(19) United States
(12) Patent Application Publication
(10) Pub. No.: US 2009/0294186 A1
(43) Pub. Date: Dec. 3, 2009

(54) Touch position determining device and method, and electronic touch-sensitive device

(76) Inventors: Luca Fontanella, Cusago (IT); Fabio Pasolini, San Martino Siccomario (IT); Benedetto Vigna, Potenza (IT); Enrico Chiesa, Besozzo (IT)

Correspondence Address: GRAYBEAL JACKSON LLP, 155 - 108TH AVENUE NE, SUITE 350, BELLEVUE, WA, 98004-5973, US

(21) Appl. No.: 11/990,384

(22) PCT Filed: Aug. 8, 2006
(86) PCT No.: PCT/EP2006/065163

§ 371 Date: Jun. 5, 2009

(30) Foreign Application Priority Data
Aug. 9, 2005 (IT) TO2005A000569

(51) Int. Cl. G08C 21/00; G06F 15/00; G06F 3/043

(52) U.S. Cl. 178/18.06; 702/150

(57) ABSTRACT

In a device for determining the position of a touch on a contact surface, a plurality of vibration sensors are configured to detect mechanical vibrations generated by the touch on the contact surface and to generate corresponding vibration signals, and a processing circuit is connected to the vibration sensors and is configured to determine the touch position via a time-of-flight algorithm, based on differences between times of detection of the mechanical vibrations by the vibration sensors.

### PRIORITY CLAIM

The present application is a national phase application filed pursuant to 35 USC § 371 of International Patent Application Serial No. PCT/EP2006/065163, published in English, filed Aug. 8, 2006; which application claims the benefit of Italian Patent Application Serial No. TO2005A000569, filed Aug. 9, 2005; all of the foregoing applications are incorporated herein by reference in their entireties.

### TECHNICAL FIELD

Embodiments of the present invention relate to a touch position determining device and method, and to an electronic touch-sensitive device. In the ensuing treatment, particular reference will be made, without this implying any loss of generality, to the field of touch-sensitive display devices (touch displays), i.e., devices where functions are activated by mere physical contact.

### BACKGROUND

As is known, the use of electronic devices provided with touch displays, which enable a user to activate given functions via a physical contact (touch) on pre-set points of a corresponding display screen, is increasing. The contact can be originated directly by the touch of a user's finger, or else can occur via a purposely provided input device, such as for example a stylus. Touch displays are provided with touch position determining devices, configured to determine the position of contact in terms of coordinates in the plane in which the display screen lies, and to transmit the position to the corresponding electronic device, in such a manner that it will issue a command for activation of corresponding functions.

A wide range of touch position determining devices are currently known, which are based principally on three technologies: capacitive technology, resistive technology, and ultrasound technology. In any case, the production of the determining devices involves complex additional processing steps in the manufacturing process of the display devices, with considerable repercussions on the manufacturing costs.

In detail, in the case of capacitive technology, an array of electrostatic capacitances is formed together with a pixel array of the display device. The array of electrostatic capacitances is constituted by electrodes made of transparent metallic material (for example, ITO—Indium Tin Oxide) so as not to be evident to the user. The physical contact on the screen causes a local variation of the capacitance value in the area in which the contact has occurred. An electronic circuit detects the capacitance variation and determines the position of contact. This solution is expensive, and is not in any case altogether invisible to the user, who perceives, in fact, a certain degradation in the quality of the images displayed. Consequently, this solution can be implemented only in applications in which image resolution and quality are not constraining design characteristics.

Resistive technology envisages formation of an array of transparent metallic wires (made, for example, of ITO), whose resistance value is altered by a touch on the display screen. The determining devices employing this technology are widely used, for example, in the aeronautic sector, but the array of metallic wires is visible to the naked eye, and consequently also in this case a non-negligible degradation in the quality of the displayed images occurs.

Ultrasound technology envisages generation of surface acoustic waves with a frequency equal to some tens of megahertz, which distribute with a given pattern over the surface of the display screen. The physical contact determines a local variation of this pattern, from which it is possible, by means of appropriate algorithms, to trace the position at which the contact has occurred. The acoustic waves are generated by a first set of piezoelectric transducers, whilst a second set of piezoelectric transducers, located in appropriate positions of the display screen, detects the pattern of acoustic waves and its alterations. This solution, unlike the ones previously described, is of an active type; i.e., it requires continuous generation of a pattern of acoustic waves on the surface of the display screen, with a consequent considerable expenditure in terms of energy.

### SUMMARY

An aim of embodiments of the present invention is consequently to provide a touch position determining device and method which is free from the drawbacks outlined above and, in particular, which is simple to produce at contained costs and, at the same time, has a high degree of precision in determining the position of contact.

### BRIEF DESCRIPTION OF THE DRAWINGS

For a better understanding of the present invention, embodiments thereof are now described purely by way of non-limiting example, with reference to the attached drawings, wherein:

FIG. 1 is a schematic illustration of a touch position determining device according to an embodiment of the present invention;

FIG. 2 is a flowchart corresponding to processing operations executed by the device of FIG. 1;

FIG. 3 shows schematic diagrams illustrating the principle of operation of the device of FIG. 1;

FIG. 4 is a partially exploded perspective view of an electronic device including the device of FIG. 1; and

FIG. 5 shows an electronic alarm system including the device of FIG. 1.

### DETAILED DESCRIPTION

The following discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

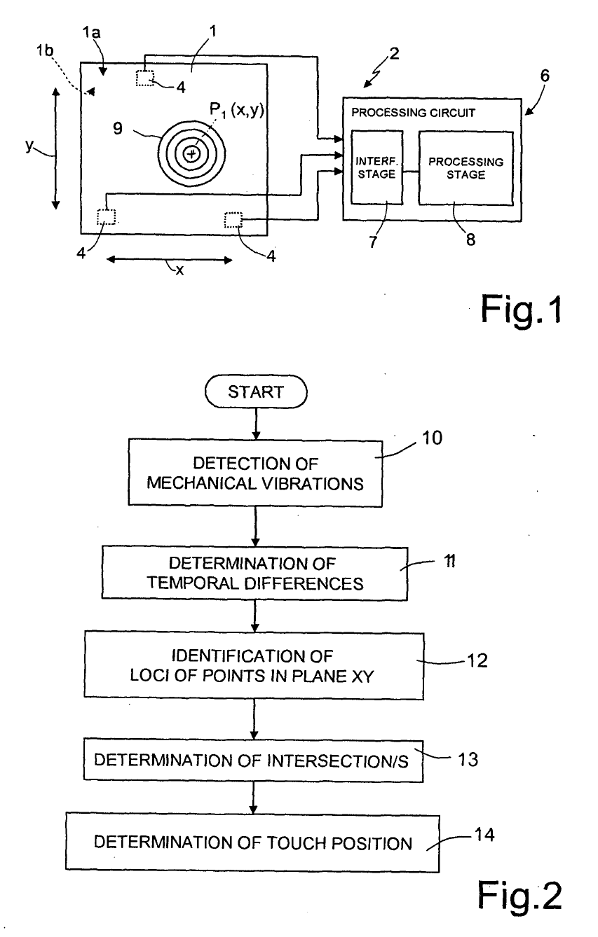

FIG. 1 shows a touch panel 1, and a touch position determining device 2 according to an embodiment of the present invention and configured to determine the position of a physical contact on the touch panel 1. It is emphasized that by the term “touch panel” is meant in what follows a rigid element designed for contact by a user, which can have any shape and size. For example, the touch panel 1 can be associated to the screen of a liquid-crystal-display (LCD) device of an electronic device, which displays icons, menus or other graphic signs, in positions at which a user can exert a contact in order to activate corresponding functions of the electronic device and/or cause new visualizations.

The touch panel 1 is made of a rigid material, for example, glass, wood or plastic, and has an outer contact surface 1a, on which contacts are generated, and an inner surface 1b. The outer contact surface 1a lies in a plane xy, and the points belonging to the outer contact surface 1a are univocally defined in a two-dimensional coordinate system (x, y). In particular, the mechanical characteristics of the touch panel 1 are such as to enable propagation of mechanical vibrations, advantageously in an isotropic manner (i.e., irrespective of the direction of propagation).

The touch position determining device 2 comprises a plurality of vibration sensors 4, in particular accelerometer sensors, fixedly coupled to the touch panel 1, and a processing circuit 6, of an electronic type, connected to the vibration sensors 4. Conveniently, the vibration sensors 4 are fixed (for example, bonded) to the inner surface 1b of the touch panel 1 so as to not be accessible to the user and so as to prevent any risks of manipulation and failure. In particular, for reasons that will be clarified hereinafter, the number of vibration sensors 4 is not less than three.

The processing circuit 6 comprises an interface stage 7, configured to acquire vibration signals generated by the vibration sensors 4, and a processing stage 8, connected to the interface stage 7 and configured to carry out, as will be described in detail hereinafter, appropriate processing operations from the vibration signals, in order to determine the position of the contact on the outer contact surface 1a.

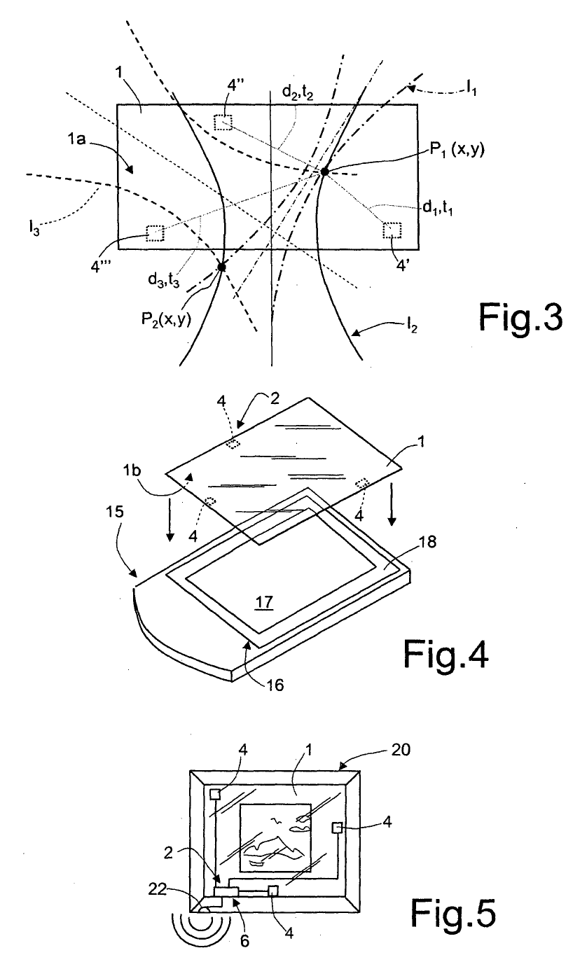

General operation of the touch position determining device 2 is described in what follows (reference is made also to FIGS. 2 and 3).

A touch in a point of contact P₁(x, y) of the outer contact surface 1a generates a pattern of mechanical vibrations, designated as a whole by 9 in FIG. 1, which propagate at a constant speed starting from the point of contact P₁(x, y) in an equivalent manner in all the directions of the plane xy, given the isotropy of the touch panel 1. In particular, the speed of propagation of the mechanical vibrations 9 depends only on the material of which the touch panel 1 is made, and varies in a known way as a function of temperature.

The vibration sensors 4 detect (block 10) the mechanical vibrations 9 generated by the touch. In particular, detection of the mechanical vibrations 9 by the various vibration sensors 4 occurs at detection times that differ according to the position of the vibration sensors 4 and to their distance from the point of contact P₁(x, y) (in particular, the term “detection time” is used to indicate the instant at which a vibration sensor 4 detects the mechanical vibrations 9).

The processing stage 8 receives the vibration signals generated by the vibration sensors 4, processes them (blocks 11-13) using an appropriate algorithm based on the time of flight, i.e., on the difference between the detection times of the various vibration sensors 4 (or, in a similar manner, between the times of arrival of the mechanical vibrations 9 in positions corresponding to the vibration sensors 4), and determines the position of the contact (block 14), in terms of coordinates (x, y) within the outer contact surface 1a.

In detail, at least three vibration sensors 4 are used to univocally obtain the position of the contact by means of an algorithm based on the time of flight.

Let P₁(x, y) (see, in particular, FIG. 3) be the point of contact on the outer contact surface 1a, and d₁, d₂ and d₃ the distances of the point of contact P₁(x, y), respectively, from a first vibration sensor 4′, a second vibration sensor 4″, and a third vibration sensor 4′″ fixed to the outer contact surface 1a (assume for example d₁<d₂<d₃). At a detection time t₁, the first vibration sensor 4′ detects the mechanical vibrations 9 generated by the contact, which are detected by the second vibration sensor 4″ at a detection time t₂, and by the third vibration sensor 4′″ at a detection time t₃.

Given that the propagation of the mechanical vibrations 9 through the touch panel 1 occurs isotropically, the following relation applies: t₃>t₂>t₁. Then, the processing stage 8 calculates (block 11) the temporal differences (in absolute value, i.e., without the information of sign) t₂−t₁, t₃−t₁ and t₃−t₂ between the detection times of all the possible pairs formed by the vibration sensors 4. From these temporal differences, given that the speed of propagation of the mechanical vibrations 9 is known, the processing stage 8 calculates the corresponding distance differences d₂−d₁, d₃−d₁ and d₃−d₂ between the distances of the point of contact P₁(x, y) from the vibration sensors 4 belonging to each pair. Then, the processing stage 8 associates to each of the distance differences (block 12) a locus of points in the plane xy that are equivalent as regards the time of flight (i.e., they give rise to the same temporal difference between the times of detection of the mechanical vibrations 9 by the vibration sensors 4 of the pair). In particular, the locus of points is a hyperbola having as focuses the positions of the two respective vibration sensors 4′, 4″, 4′″ of the pair. The hyperbola is in fact by definition the locus of the points whereby the difference of the distances from two fixed points referred to as focuses is constant. Accordingly, the processing stage 8 identifies: a first hyperbola I₁ having as focuses the first vibration sensor 4′ and the second vibration sensor 4″, a second hyperbola I₂ having as focuses the first vibration sensor 4′ and the third vibration sensor 4′″, and a third hyperbola I₃ having as focuses the second vibration sensor 4″ and the third vibration sensor 4′″. As illustrated in FIG. 3, the three hyperbolas I₁-I₃ intersect in two points: the point of contact P₁(x, y) belonging to the contact surface 1a, and a further point of intersection P₂(x, y). It is sufficient to arrange the vibration sensors 4 in the proximity of the peripheral edges of the touch panel 1 for the further point of intersection P₂(x, y) to be located outside of the contact surface 1a (as illustrated in FIG. 3). Then, the processing stage 8 determines (block 13) the coordinates of the intersections of the three hyperbolas I₁-I₃, rejects the point of intersection falling outside the contact surface 1a, and considers the coordinates of the point of intersection belonging to the contact surface 1a. These coordinates correspond to the position of the point of contact P₁(x, y), which can thus be univocally determined by the processing stage 8 (block 14). In fact, the intersection is the single point of the contact surface 1a that satisfies the relations of time of flight associated to the detection times t₁, t₂, t₃ of the vibration sensors 4′, 4″, 4′″.

In particular, just two vibration sensors 4′, 4″ are not sufficient to univocally determine the point of contact P₁(x, y): in fact, the algorithm described, on the basis of the only difference t₂−t₁ between the detection times of the two vibration sensors, would lead in this case to determination of a locus of points (i.e., the hyperbola having as focuses the positions of the two vibration sensors 4′, 4″) that are absolutely equivalent, and hence are indistinguishable as regards the time of flight.

Furthermore, the effective position of the vibration sensors 4 with respect to the touch panel 1 is not a determining factor for the purposes of the algorithm described, and consequently the vibration sensors 4 can be arranged at arbitrary positions (provided that they are arranged, however, in the proximity of the periphery of the touch panel 1), according, for example, to specific production requirements.

Advantageously, the number of vibration sensors 4 used for determining the point of contact P₁(x, y) can be greater than three. In particular, if at least four vibration sensors 4 are used, the intersection of the hyperbolas identified as previously described is just one (in a position corresponding to the point of contact P₁(x, y)). In this case, consequently, it is not necessary to arrange the vibration sensors 4 in the proximity of the edges of the touch panel 1 (thus, the vibration sensors 4 can be arranged in an altogether arbitrary manner with respect to the touch panel 1), and the processing stage 8 does not carry out any further processing operations beyond determination of the intersection, in order to identify the point of contact P₁(x, y).

FIG. 4 shows an electronic device 15, in particular a PDA (Personal Digital or Data Assistant), provided with a touch display 16, for example, of the liquid-crystal type (LCD), and with the touch position determining device 2 described above. In detail, the touch display 16 has a touch screen, comprising: a display screen 17, a frame 18, surrounding the display screen 17 and having a supporting function; and the touch panel 1, which is transparent, is preferably made of glass, and is superimposed on the display screen 17 and supported by the frame 18. The vibration sensors 4 (as has been said, not less than three in number) are fixed, for example, bonded or carried by suction caps (not shown), to the touch panel 1. In use, the vibration sensors 4 are arranged between the touch panel 1 and the frame 18. The processing circuit 6, connected to the vibration sensors 4 for determining the position of contact, is in this case conveniently integrated in the control electronics (not shown) that supervises general operation of the touch display 16.

Texts, icons, or other graphic signs are displayed on the display screen 17, and to each of them is associated a given function of the electronic device 15 or a given visualization on the display screen 17. A touch on the outer contact surface 1a generates mechanical vibrations which propagate towards, and are detected by, the vibration sensors 4. The processing circuit 6 (FIG. 1) thus determines univocally the position at which the touch has occurred on the basis of the differences between the times of arrival of the mechanical vibrations to the various vibration sensors 4, and transmits this position to the control electronics of the electronic device 15, which activates the corresponding functions/visualizations.

FIG. 5 shows a further application of the touch position determining device 2 as alarm system, for example, for the protection of a show case 20. In this case, the touch panel 1 is constituted by a glass plate of the show case 20, and the vibration sensors 4 are fixed to the inner surface 1b of the touch panel 1. The processing circuit 6 (FIG. 1) is connected to an alarm device 22 (for example, a siren), which activates upon detection of a theft attempt (i.e., upon detection of a contact on the touch panel 1). In particular, the processing circuit 6, via the algorithm described above, enables univocal identification of the coordinates of the point at which the theft attempt has been made.

Various embodiments of the touch position determining device have the following advantages, with all such advantages not necessarily being present in all embodiments and not limiting the scope of the appended claims.

In the first place, embodiments of the present invention do not entail any complex and costly additional manufacturing steps, in so far as the vibration sensors 4 can be applied in a simple manner at the end of the manufacturing process of any display device or of a generic electronic device. Furthermore, the presence and provision of electrodes and/or wires that would be visible to the naked eye, thus jeopardizing the quality of display of the images, is not necessary.

The spatial resolution with which the position of contact is determined is high. In fact, considering a typical speed of propagation of mechanical vibrations of 3.5 km/s, to have a spatial resolution Δx of 1 mm, it is necessary for the electronic circuit 6 to appreciate a temporal difference Δt between the detection times of the various vibration sensors 4 of:

$$Δ t = \frac{Δ x}{v} = \frac{{10}^{- 3}}{3 \cdot {10}^{3}} = 0.3 µs$$

It is consequently necessary to discriminate the time of flight with a precision in the region of a microsecond, a temporal difference that is altogether compatible with the electronics available on the market.

The power consumption is reduced, in so far as the determining device is of a passive type and does not envisage continuous generation of a pattern of acoustic waves. The determining device is sturdy and not easily subject to damage.

In addition, use of a number of vibration sensors 4 greater than three (for example, four vibration sensors) is advantageous in so far as the point of intersection between the various hyperbolas is unique.

Finally, it is clear that modifications and variations may be made to what is described and illustrated herein without thereby departing from the scope of the present invention, as defined in the annexed claims.

In particular, if a number of vibration sensors 4 equal to three is used, the problem of the non-uniqueness of the intersection between the various hyperbolas I₁-I₃ can be solved in an alternative way, without arranging the vibration sensors 4 in the proximity of the edges of the control panel 1. In detail, the processing stage 8 (FIG. 1) can be configured to determine also the information of sign of the temporal differences between the detection times of the mechanical vibrations 9, and to use this information of sign in order to discriminate the point of contact P₁(x, y) between the two resulting intersection points. In fact, only one of the two intersection points (i.e., the point of contact P₁(x, y)) satisfies the conditions on the temporal differences, if it is considered with sign, whereas the further point of contact P₂(x, y) is rejected by the processing stage 8.

The vibration sensors 4 may be microphones or piezoelectric sensors, instead of accelerometer sensors, or in any case sensors of movement capable of detecting the presence of the vibrations generated by the touch on the contact surface.

The described device can advantageously be applied in numerous other applications, for example, in the field of toys, for making a light-up board that changes color or lights up where a contact has occurred (the coordinates of contact being determined as previously described). In this case, the touch panel 1 is constituted by the same light-up board, or by an outer casing thereof.

The touch position determining device can advantageously be used not only in display devices of an LCD type, but also to make touch sensitive display devices of any other type (for example, Cathode Ray Tube (CRT), Organic Light Emitting Diode (OLED), etc.).

The arrangement of the vibration sensors 4 can be different; for example, they can be fixed to the outer contact surface 1a, instead of to the inner surface 1b. The vibration sensors 4 can also be directly fixed to the screen 17 of the display device 16, without any need for providing any additional touch panel.

From the foregoing it will be appreciated that, although specific embodiments of the invention have been described herein for purposes of illustration, various modifications may be made without deviating from the spirit and scope of the invention.

1. A device for determining the position of a touch on a contact surface, comprising:
a plurality of vibration sensors configured to detect mechanical vibrations generated by said touch on said contact surface and to generate corresponding vibration signals; and
a processing circuit connected to said vibration sensors and configured to determine said touch position based on said vibration signals.

2. The device according to claim 1, wherein said processing circuit is configured to determine said touch position via a time-of-flight algorithm, on the basis of times of detection of said mechanical vibrations by said vibration sensors.

3. The device according to claim 1, wherein said contact surface lies in a plane, and said processing circuit is configured to determine temporal differences between times of detection of said mechanical vibrations by vibration sensors belonging to pairs of said vibration sensors, and to identify loci of points of said plane corresponding to said temporal differences; said touch position being determined as the point of intersection of said loci of points belonging to said contact surface.

4. The device according to claim 3, wherein each of said loci of points is a hyperbola having as focuses positions of the vibration sensors of a respective one of said pairs.

5. The device according to claim 1, wherein the number of said vibration sensors is not less than three.

6. The device according to claim 1, wherein said vibration sensors are accelerometer sensors.

7. The device according to claim 1, wherein said vibration sensors are rigidly coupled to said contact surface.

8. The device according to claim 7, wherein said contact surface is an outer surface of a touch panel, and said touch panel has an inner surface opposite to said contact surface; said vibration sensors being fixed to said inner surface.

9. An electronic touch-sensitive device, comprising a contact surface and a device for determining the position of a touch on said contact surface, said device being made according to claim 1.

10. The electronic device according to claim 9, wherein said contact surface is made of a rigid material, configured to transmit at least partially and isotropically mechanical vibrations.

11. The electronic device according to claim 9, wherein said electronic device is a touch display.

12. The electronic device according to claim 11, comprising a display screen, a frame surrounding said display screen, and a touch panel made of a rigid material configured to transmit at least partially and isotropically said mechanical vibrations and including said contact surface; said touch panel being superimposed on said display screen and supported by said frame, and said vibration sensors being arranged between said frame and said touch panel.

13. The electronic device according to claim 11, wherein the touch display comprises one of an LCD, CRT and OLED display.

14. The electronic device according to claim 9, wherein the device comprises a personal digital assistant.

15. A method for determining the position of a touch on a contact surface, comprising:
detecting vibration signals at a plurality of detection points fixed to said contact surface, said vibration signals being a function of mechanical vibrations generated by said touch on said contact surface; and
processing said vibration signals for determining said touch position.

16. The method according to claim 15, wherein said processing step comprises determining said touch position via a time-of-flight algorithm, on the basis of times of detection of said mechanical vibrations at said detection points.

17. The method according to claim 15, wherein said contact surface lies in a plane, and said processing step comprises:
determining temporal differences between times of detection of said mechanical vibrations at detection points belonging to pairs of said detection points;
identifying loci of points belonging to said plane corresponding to said temporal differences; and
determining said touch position as the point of intersection of said loci of points belonging to said contact surface.

18. The method according to claim 17, wherein each of said loci of points is a hyperbola having as focuses the detection points of a respective one of said pairs of detection points.

19. The method according to claim 15, wherein the number of said detection points is not less than three.

20. The method according to claim 15, further comprising providing vibration sensors at said detection points in such a manner that said vibration sensors are sensitive to mechanical vibrations generated by said touch on said contact surface; providing vibration sensors comprising mechanically coupling said vibration sensors to said contact surface.

21. A touch position determining device, comprising:
a plurality of vibration sensors adapted to be arranged on a contact surface, each vibration sensor operable to detect mechanical vibrations through the contact surface generated by a point of contact on the contact surface, and each sensor further operable to generate a corresponding vibration signal responsive to the detected mechanical vibrations; and
a processing circuit coupled to the vibration sensors and operable to determine the point of contact from the vibration signals.

22. The touch position determining device of claim 21 wherein the contact surface comprises a touch panel adapted to be attached to a display screen.

23. The touch screen position determining device of claim 21 wherein the mechanical vibrations propagate through the contact surface at the same rate in all directions of propagation.

24. The touch position determining device of claim 21 wherein the processing circuit is operable to determine the differences in detection times between pairs of the vibration sensors, wherein the detection time of each sensor corresponds to the instant at which each sensor first detects a mechanical vibration generated by the point of contact.

25. The touch position determining device of claim 24,
wherein the processing circuit is further operable to generate for each pair of vibration sensors a plurality of potential points of contact from the corresponding difference in detection times, each plurality of potential points of contact forming a curve of potential contact points; and
wherein the processing circuit is further operable to determine the, point of contact on the contact surface as a point on the contact surface defined by the intersection of the curves of potential contact points.

26. The touch position determining device of claim 25 wherein each curve of potential contact points is a hyperbola having as foci the positions of the corresponding pair of vibration sensors and wherein the number of vibration sensors is not less than three.

27. The touch position determining device of claim 21, wherein said vibration sensors are accelerometer sensors.

28. An electronic device, comprising:
a visual display; and
a touch position determining device coupled to the visual display, the touch position determining device including,
a plurality of vibration sensors arranged on a contact surface, each vibration sensor operable to detect mechanical vibrations through the contact surface generated by a point of contact on the contact surface, and each sensor further operable to generate a corresponding vibration signal responsive to the detected mechanical vibrations; and
a processing circuit coupled to the vibration sensors and operable to determine the point of contact from the vibration signals.

29. The electronic device of claim 28 wherein the visual display comprises one of an LCD, CRT and OLED display.

30. The electronic device of claim 28 wherein the device comprises a personal digital assistant.

31. A method for determining the position of a point of contact on a contact surface, comprising:
at a plurality of locations on the contact surface, detecting mechanical vibrations propagating through the contact surface in response to the contact surface being touched at the point of contact; and
determining the point of contact from the mechanical vibrations.

32. The method of claim 31 wherein determining the point of contact from the mechanical vibrations comprises determining the differences in detection times between pairs of locations on the contact surface, wherein the detection time at each location corresponds to the instant at which a mechanical vibration generated by the touch at the point of contact is detected at the location.

33. The method of claim 31 wherein the absolute values of the differences in detection times are utilized for each pair of locations.

34. The method of claim 32 further comprising:
calculating for each pair of locations a plurality of potential points of contact from the corresponding difference in detection times, each plurality of potential points of contact forming a curve of potential contact points;
determining the intersection of the curves on the contact surface; and
determining the point of contact at which the contact surface was touched is equal to the intersection of the curves.
